(19) United States
(12) Patent Application Publication
(10) Pub. No.: US 2025/0036356 A1
(43) Pub. Date: Jan. 30, 2025

(54) Automatically Generating Audio Descriptions for Image Content

(71) Applicant: International Business Machines Corporation, Armonk, NY (US)

(72) Inventors: Mikael Hillborg, Umeå (SE); Bhanu Suresh, Bengaluru (IN); Bindu Umesh, Bangalore (IN); Deepa Dhanaraj, Bangalore (IN); Soumya Menon, Ahmedabad (IN)

(21) Appl. No.: 18/226,315

(22) Filed: Jul. 26, 2023

(51) Int. Cl. G06F 3/16; G06F 16/632; G06V 20/40

(52) U.S. Cl. CPC G06F 3/167; G06F 16/632; G06V 20/46

(57) ABSTRACT

Mechanisms are provided for generating audio descriptions of visual elements of video content. A plurality of extracted video features for the video content are received from an image recognition and analysis system. Based on the extracted video features, one or more audio descriptions are generated that describe the extracted video features audibly. At least one temporal location within the video content is determined, in which to place the one or more audio descriptions so as to minimize overlap with other audio features of the video content and other audio descriptions. An audio description data structure is generated that specifies the temporal location(s) within the video content for the one or more audio descriptions. The audio description data structure is provided to a client computing device for playback of the video content including output of the one or more audio descriptions.

### BACKGROUND

The present application relates generally to an improved data processing apparatus and method and more specifically to an improved computing tool and improved computing tool operations/functionality for automatically generating audio descriptions for image content.

With the increased ability to share content via the Internet, social networking websites, and the readily available nature of image and video producing devices, e.g., smart phones and the like, visual content, e.g., images and digital video content (or “videos”) are quickly becoming the primary format for sharing content with other users. Videos include movies, tutorials, demos, how-to procedures, theatre, television, and so on. For blind and visually impaired (BVI) users, some videos are not useful as the content is completely visual or significant information in the video comes from the portion of the content that can only be perceived visually, e.g., an animated movie where characters and actions are occurring but there is no related audio, such as in the case of scenes with only a musical score as audio. In such cases, the information gathering or entertainment experience for such videos, e.g., movies, differs as the BVI users might not identify the details on the screen and might not be able to interpret the scene completely.

In order to address these issues, providers of videos may provide audio descriptions, or third parties may provide such audio descriptions, to augment the content of the video. An audio description is narration added to the soundtrack to describe important visual details that cannot be understood from the main soundtrack alone. Audio description is a means to inform individuals who are blind, or who have low vision, about visual content essential for comprehension. Audio description of video provides information about actions, characters, scene changes, on-screen text, and other visual content. Audio description supplements the regular audio track of a program. Audio description is usually added during existing pauses in dialogue. Audio description is also called “video description” and “descriptive narration”.

However, creating, adding, and supplementing audio description to a video is a manual process that requires much time and manual resources to accomplish.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method, in a data processing system, is provided for generating audio descriptions of visual elements of video content. The method comprises receiving a plurality of extracted video features for the video content from an image recognition and analysis computing system that performs image recognition operations to extract video features from the video content. The method also comprises generating, based on the extracted video features, one or more audio descriptions that describe the extracted video features audibly, and determining at least one temporal location within the video content in which to place the one or more audio descriptions. The at least one temporal location is determined based on a criterion to minimize overlap of the one or more audio descriptions with other audio features of the video content and other audio descriptions. The method further comprises generating an audio description data structure specifying the at least one temporal location within the video content for the one or more audio descriptions. In addition, the method comprises providing the audio description data structure to a client computing device for playback of the video content and output of the one or more audio descriptions during the playback of the video content.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is an example diagram of a distributed data processing system environment in which aspects of the illustrative embodiments may be implemented and at least some of the computer code involved in performing the inventive methods may be executed;

FIG. 2 is an example block diagram illustrating the primary operational components of an automatic audio description (AAD) generator in accordance with one illustrative embodiment;

FIG. 3 is a flowchart outlining an example overall operation for automatically generating audio descriptions for video content in accordance with one illustrative embodiment; and

FIG. 4 is a flowchart outlining an example operation for automatically locating audio descriptions in accordance with one illustrative embodiment.

### DETAILED DESCRIPTION

The illustrative embodiments provide an improved computing tool and improved computing tool operations/functionality to automatically generate audio descriptions for image content. The illustrative embodiments utilize artificial intelligence (AI) based image analysis on image content, hereafter assumed to be digital videos (but also applicable to still image content as well), to identify elements of the video and extract them as video features, e.g., characters, objects, actions being performed, scene changes, on-screen text, and other visual aspects of the video. These video “features” may be any recognizable visual element within the displayable images of the video content. The video “features” are first identified as unknown types of features and then the properties of the identified features, e.g., shape, color, and other properties of the identified features, may then be used as a basis to classify the identified features into predetermined types of features, e.g., an object may be an unidentified object and then may be classified as a “car” or a “cat” based on its properties.

A user customized filter may then be applied to these classified video features to identify video features of interest and to identify a desired level of audio description for the particular video content, or portion of video content, e.g., particular scenes or types of scenes present in the video. A natural language processing (NLP) engine operates on the filtered video features to construct a textual description of the filtered video features in accordance with the user's desired level of audio description and structural elements of the video content. The textual description may then be converted to an audio description by text-to-speech (TTS) logic, such as IBM Watson TTS™, available from International Business Machines (IBM) Corporation of Armonk, New York, or the like.

The structural elements of the video refers to the formatting of the video content and the annotations or metadata specifying the formatting of the video content, e.g., boundary markers that mark the beginning/end of scenes, segments, or other defined portions of video content and its corresponding audio soundtrack, e.g., existing music, dialog, sound effects, etc. The structural elements may further specify properties of the structural elements that may be used to control automatic audio description generation, such as types of scenes associated with the boundary markers, or the like, e.g., a start boundary at 32 minutes into the video content playback with the scene being an “action” scene, and a end boundary of that scene being at 37 minutes into the video content playback.

The structural elements of the video content and its corresponding audio soundtrack may inform the mechanisms of the illustrative embodiments as to the size in terms of temporal length of scenes, segments, or other defined portions of the video/audio soundtrack. This size or length may be compared to the size/length of the NLP engine/TTS logic generated audio description, as well as possibly other automatically generated audio descriptions and their relative positioning to scenes, segments, etc. so as to automatically adjust the placement and lengths of the audio descriptions to fit within the confines of the structure of the video content. That is, the structure of the video content poses limits on the size and placement of the audio description in relation to the visual content of the video since it is desirable to correlate the audio descriptions with the specific scenes or segments of video content to which they pertain, i.e., the scenes or segments that the audio descriptions are describing. This placement may be further limited by evaluations of overlapping audio not only with regard to the existing audio soundtrack of the video, but also with other automatically generated audio descriptions in some cases.

In some illustrative embodiments, automated logic is provided for determining relative placement of the audio descriptions within the scenes of the video to avoid overlap with other audio descriptions and other existing audio content, or features, associated with the video, e.g., the existing soundtrack. In determining this relative placement, the automated logic may implement fallback logic for falling back the level of audio description to a less verbose or detailed audio description, i.e., audio descriptions that are smaller in size/length from a temporal standpoint, especially in situations where the more verbose or detailed audio description does not allow for avoidance of overlap or which may extend beyond the corresponding scene or segment. Multiple different levels of verbosity and detail may be defined based on the desired implementation. The automated logic may iteratively attempt generation of an audio description that fits within the confines of the structural elements of the video content to minimize overlap, such as by iteratively reducing the level of verbosity or detail, and thereby override user specified levels of detail when needed to accommodate structural limitations of the video/audio soundtrack.

The resulting automatically generated audio descriptions and their placement in relation to the video content may be stored as audio description data structures which includes not only the audio descriptions themselves, by data specifying the temporal location(s) during a playback of the video content where the audio descriptions are to be output to a user. In some cases, cue data structures may also be generated in conjunction with the audio description data in order to specify playback speed/rate controls to avoid overlap of audio descriptions. That is, if a portion of the video content has a large number of video features present, and thus, the audio descriptions may be lengthy such that they are not able to be satisfactorily located to avoid overlap, then a cue point may be set specifying a change in playback speed/rate of the video content so as to extend the available rendering window for the audio descriptions and thereby avoid overlap. These cues may be compiled into a cue data structure which may be provided along with the audio description data structures for use during playback of the video content.

The audio description data structure, and cue data structures if any, may be stored in a cloud computing system or cloud storage, such that it may be retrieved by various users when requesting audio description augmented video for playback. The audio description data and cue data may be stored in association with characteristics of the user for which it was originally generated, and those characteristics may be compared to characteristics of the current user requesting audio description augmented video content to determine a closest match. If a closest match within a given tolerance is not able to be identified, then the process of automatically generating the audio descriptions may be implemented to thereby generate the audio description for playback with the video content. If a closest match within a given tolerance is found, then that audio description augmented video content may then be provided to the user for playback.

It should be appreciated that the mechanisms of the illustrative embodiments may executed in an offline process, i.e., prior to a user requesting the audio description augmented video content, or as part of an online process, e.g., generating the audio description augmented video content in response to a user request. In some illustrative embodiments, the audio description augmented video content may be generated dynamically as the video content is being streamed or provided to the user. That is, a lookahead mechanism may be implemented in which upcoming scenes in the video may be analyzed and augmented by the mechanisms of the illustrative embodiments prior to outputting the audio description augmented video content to the user and while the user is viewing portions of the video occurring prior to the upcoming scenes, e.g., while scene 1 is being watched by the user, a later scene, e.g., scene 5, may be analyzed and audio descriptions automatically generated. That is, the mechanisms of the illustrative embodiments may operate on a second portion of video content that is to be output by a video player system at a future point in time during a playback of the video content, while a first portion of the video content is being output by the video player system during the playback of the video content.

Thus, the illustrative embodiments provide improved computing tools and improved computing tool operations/functionality to enhance replay of videos or presentation of image content, such that blind and visually impaired (BVI) persons are informed of visual features of the video content that are not otherwise able to be discerned by them from the associated audio content, e.g., the soundtrack. The illustrative embodiments automate the process of generating audio descriptions for BVI persons by implementing a specific AI image analysis mechanism with NLP and TTS mechanisms for automatically generating the audio descriptions, as well as automated placement logic for determining optimum placement of automatically generated audio descriptions relative to the video content so as to minimize audio overlap and meet with user specified preferences.

During a runtime operation, in response to a BVI user wanting to consume a non-accessible video, i.e., a video for which there is currently no available associated audio description such that BVI users are able to fully experience the video content, the BVI user may invoke the operation of the illustrative embodiments to either retrieve a previously automatically generated audio description stored in a cloud storage system for a similar user, or to automatically generate the audio description for presentation to the BVI user while consuming the video content, as well as to store the automatically generated audio description in the cloud storage system for later retrieval. The automatic audio description (AAD) generator of the illustrative embodiments automatically creates an audio description by using image recognition, where the extracted image or video features obtained from the image recognition (which are detected and classified/labeled by the image recognition computer model(s) based on properties of the identified features) are used to tailor the automatically generated audio descriptions according to the BVI user's own preferences with regard to audio description. Moreover, the automatically generated audio descriptions may be associated with segments or scenes of the video content taking into account the structural limitations of the video content relative to the lengths of the audio descriptions that are generated. Automatic fallback evaluations may further be implemented so as automatically adapt the audio descriptions to the available audio space of the particular scene or segment of the video content, i.e., a portion of video content between boundary markers in the video content that mark the beginning and end of a scene, segment, or other defined portion of video/audio content.

In some illustrative embodiments, the tailoring of the audio descriptions and the automatic adjustment of the audio descriptions based on structural limitations of the video content may be based on various predefined levels of audio description. For example, in some illustrative embodiments, three levels of audio description may be predefined, e.g., minimum, moderate, and maximum. For a minimum level of audio description, for example, the minimum audio description may include only an audio description of the video content elements shown on the screen. That is, with the “minimum” level of audio description, there are no additional descriptions of these elements other than their identification, e.g., identification of the detected actions, objects, and other features of the video content extracted via image analysis. The BVI user will neither get modifiers to the nouns/verbs, nor positional information about the features, e.g., relative locations of the features within the depicted scene, such as “A man to the left of a car”. For example, an audio description having a minimum level may be of the type “A man” and “A car”.

For a moderate level audio description, the moderate description may describe the elements with a more thorough description. For example, with the moderate level of audio description, the BVI user will be provided modifiers to the nouns/verbs but no positional information, for example “A large man” and “A red car”, but not “a large man inside a red car”.

For a maximum level audio description, the maximal video description provides a rich description of what is occurring in the video scene or segment. For example, with the maximum level of audio description, the BVI user will be provided modifiers to the nouns/verbs and positional information. Positional information will inform how the elements, represented by the extracted features via the image recognition analysis, are positioned relative to each other in the video frames of the video scene, for example “A man to the left of a red car”.

It should be appreciated that with each of these various levels of audio description, further settings may be specified to select the types of description within the levels that a BVI user wishes to hear in the audio descriptions. For example, the user may not wish to hear about background elements of the video content, or may only be concerned with the characters present in the scenes. Thus, features that are background elements or which are not specifically concerned with the characters present in the video scene may be eliminated as sources of audio description even within the specified levels of audio description, e.g., if the moderate level would normally describe an object in the scene, but that object is not directly related to the characters in the scene, the audio description of that object may not be generated.

These are only examples of the levels of audio description that may be utilized with illustrative embodiments of the present invention. It should be appreciated that in other illustrative embodiments, more or fewer levels of audio description may be provided and the various levels of audio description may be alternatively defined with regard to the types of detail, modifiers, positional information, action types, and other detailed information that is descriptive of the elements of the video content, that may be used to generate audio descriptions automatically. Any such implementation of levels of audio description and their corresponding types and richness of descriptive content may be used without departing from the spirit and scope of the present invention.

The user may define a user profile specifying characteristics of the user and user preferences that comprise the corresponding level, or levels, of audio description that the user wishes to use as part of the automatic generation of audio descriptions for video content. Moreover, the user profile may specify user modifications to these levels of audio description, e.g., specific preferences of the user as to elements within each level of audio description that the user wants, or does not want, to be included in the audio descriptions. For example, features of a certain type, such as a background feature type, which holds features that describe the sky, the ground, large fields, a forest, etc. may be a feature type that is filtered out with regard to automatic generation of audio descriptions. These are referred to herein as video element filters within the level of audio description.

In some illustrative embodiments, these video element filters may comprise a lookback time filter. The lookback time filter specifies a time period of an elapsed time of the video content playback in which the audio description of a video element or features is not to be repeated. That is, video elements or features can be filtered out based on when they last occurred in time. A value of 20 with regard to a lookback time filter associated with a particular video element/feature type, for example, means that the video element/feature of that specific type must have occurred longer than 20 seconds ago to be described again in an audio description. This helps to avoid frequent and repeated audio descriptions of the same video element/feature. Of course, there may be overriding criteria specified that overrides this lookback time filter, such as a scene change as indicated by the traversal during playback of a scene boundary marker or other specification of a boundary of a scene or portion of the video content, e.g., if a video element/feature occurs in multiple sequential scenes, the scene change may permit inclusion of the audio description of that video element/feature again since the scene has changed, even if the occurrence of that video element/feature is within the lookback time filter time period.

It should be appreciated that the user profile may associate different levels of audio description, and corresponding video element filters within the levels of audio description, with different types of video content. These different levels of audio description may be specified for entire videos, or even types of scenes within videos. For example, if a video is classified as a drama, such as via metadata associated with the video content data, the user may specify for dramas that a maximum level of audio description is desired, as the scenes in the video will likely have longer time lengths and will have less rapid action than other types of video, allowing for more rich descriptions to enhance the experience. If a video is classified as an action video, then scenes may be more rapidly changing and there may be more action and elements in each scene which will make it more difficult to fit audio descriptions within the confines of the video structure and hence, the user may specify that a minimum audio description is to be utilized. If a video is an animated video, the user may specify that a maximum audio description level is to be utilize as there will likely be scenes with elements that are not represented in the audio soundtrack of the animated video, e.g., scenes with just a musical score and animation and hence, a richer description of the scenes may be required. This specification can be associated with different types of videos, different types of scenes, or the like. In some cases, the levels of audio description may be tied to the specific types of video elements, or features, found within the scene, e.g., scenes having only background content may have a maximal level of audio description, while scenes with characters conversing may have a minimal level of audio description. The various levels of audio description allow for a dynamic and automatic modification of audio description verbosity and detail, and the tailoring of the audio descriptions to the particular video content and the preferences of the BVI user.

The characteristics of the user that are represented in the user profile may comprise any descriptive information about the user that can be used to identify other similar users for purposes of retrieving previously automatically generated audio descriptions for video content. These characteristics may include demographic information, user preferences for audio descriptions, and the like. In some cases, the characteristics may include the specific classification of the visual impairment of the user, e.g., moderate visual impairment, severe visual impairment, blindness, etc., as there are different levels of visual impairment and individuals with similar conditions may have similar requirements or preferences for the verbosity or detail level of audio descriptions. Any suitable characteristics of the user that may be a basis for identifying similar users for purposes of identifying audio descriptions that satisfy the requirements of the user may be used without departing from the spirit and scope of the present invention.

In some illustrative embodiments, the user profile may further specify whether the user permits automated adaptive modification of the level of audio description, i.e., the audio description level fallback functionality mentioned previously, which is also referred to herein as a “richness fallback” functionality. With this richness fallback functionality, if many video elements or features are found to exist in a video scene or segment via the image recognition and analysis mechanisms of the illustrative embodiments, and the user has chosen a higher level of audio description, e.g., a maximum option, the mechanisms of the illustrative embodiments may automatically and dynamically fall back to either the moderate or minimum options to check if they fit into the rendering window before the next boundary point is processed. This may be done iteratively going from a higher level of verbosity or detail to a lower level until a level of audio description is found that permits the audio description to be fit into the rendering window, where the rendering window is a temporal portion of the audio accompanying the video that minimizes overlap with other audio content in terms of the audio soundtrack of the video content and/or other automatically generated audio descriptions.

It should be appreciated that even with the richness fallback functionality enabled, there may be situations in which even the lowest level of audio description may not be able to fit within a rendering window. In such cases, if the lowest level of audio description is not enough to keep the pace with the video, the illustrative embodiments may adjust the speed of the video playback by inserting cue points that cause a call from a localized synchronization module to a rate controller API of the video player engine which adjusts the speed of the video to increase the available rendering window. Thus, in some illustrative embodiments, the video playback may be automatically adjusted to allow for the inclusion of an automatically generated audio description of a given scene of the video content. The speed of the video playback may be likewise adjusted back to its original speed, by insertion of another cue point, once it is determined that the video playback at its original speed will allow for rendering windows using at least the minimum level of audio description.

As noted above, the audio descriptions that are automatically generated by the mechanisms of the illustrative embodiments are tied to video elements or features identified through image recognition and analysis mechanisms that extract the features representative of objects, actions, and other video content elements. The image recognition and analysis mechanisms may be any known or later developed image recognition and analysis mechanisms that identify and extract image features representative of such objects, actions, etc., and classify these extracted features, based on their properties (e.g., size, shape, color, etc.) with regard to what they represent in accordance with predefined classifications, e.g., classifying an extracted feature as an object that is a “ball” or a “table” etc. The image recognition and analysis mechanisms label the corresponding objects with the classifications. This image recognition and analysis may be performed at a time remote from the time of automatic audio description generation and may store the image recognition and analysis results, e.g., the classifications of extracted features, as metadata content or as a separate data structure in association with the video content, such as on a scene by scene basis. Thus, the video content may include metadata that specifies the boundaries of the scenes, e.g., boundary points/markers, and metadata that specifies the extracted features and their classifications within each scene.

In some illustrative embodiments, with the image recognition and analysis mechanisms, video features that are recognized, are surrounded by a box (internally by the system, not visible for the user) and each video feature's area in relation to how much of the displayable picture it covers may be calculated, e.g., in terms of percent, such as 5% of the displayable picture. The user preferences specified in the user profile may indicate to filter out features that are very small and consequently not in the focus of the particular scene, where “very small” may be specified in terms of a threshold percentage, or other measure, of the displayable picture. For example, a user may specify a value threshold in the user profile settings, such as 0.1, which means 0.1% of the screen area.

Thus, the illustrative embodiments provide an improved computing tool and improved computing tool operations/functionality to automatically, and in some cases dynamically, generate audio descriptions for video content to assist blind and visually impaired (BVI) users in experiencing the video content. The mechanisms of the illustrative embodiments leverage artificial intelligence (AI) based image recognition, analysis, and classification computing tools to identify video elements/features, classify them, and label them. The mechanisms of the illustrative embodiments augment these AI mechanisms by providing additional specific computing mechanisms that operate to automatically generate audio descriptions in accordance with the structural limitations of the video content and corresponding audio soundtracks, the preferences of users, and various filters and optimizations to minimize audio overlap of audio descriptions. All of these features operate to automatically and dynamically enhance the experience of BVI users when consuming video content.

It should be appreciated that while the primary focus of the improvements provided by the improved computing tool and improved computing tool operations/functionality are directed towards BVI users, the illustrative embodiments are not limited to use by BVI users. To the contrary, it is recognized that users that are not classified as BVI users may also make use of the mechanisms of the illustrative embodiments. That is, users of various levels of visual capabilities consume media in different ways, e.g., using headphones and a mobile phone, using streaming services, etc., and may not always be able to view the actual video content itself. In such cases, users may obtain value added from audio descriptions generated by the mechanisms of the illustrative embodiments by enabling automated audio descriptions.

Moreover, it should be appreciated that video content generation is a rapid and ever increasing area with more and more video content being generated on a daily basis. It is not practical for manual efforts to generate audio descriptions to keep pace with the amount of video content being generated and thus, vast amounts of video content are not augmented with audio descriptions due to manual resource limitations. As a result, many BVI users are not able to fully experience this video content due to the lack of audio descriptions. By having an automated audio description generator computing tool, such as that provided by the illustrative embodiments, a much larger amount of this video content may be augmented automatically, and even dynamically in response to user requests to access video content, with audio descriptions making the amount of accessible video content for BVI users greatly increased.

Before continuing the discussion of the various aspects of the illustrative embodiments and the improved computer operations performed by the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on hardware to thereby configure the hardware to implement the specialized functionality of the present invention which the hardware would not otherwise be able to perform, software instructions stored on a medium such that the instructions are readily executable by hardware to thereby specifically configure the hardware to perform the recited functionality and specific computer operations described herein, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular technological implementation for accomplishing and/or performing the actions, steps, processes, etc., attributable to and/or performed by the engine, but is limited in that the “engine” is implemented in computer technology and its actions, steps, processes, etc. are not performed as mental processes or performed through manual effort, even if the engine may work in conjunction with manual input or may provide output intended for manual or mental consumption. The engine is implemented as one or more of software executing on hardware, dedicated hardware, and/or firmware, or any combination thereof, that is specifically configured to perform the specified functions. The hardware may include, but is not limited to, use of a processor in combination with appropriate software loaded or stored in a machine readable memory and executed by the processor to thereby specifically configure the processor for a specialized purpose that comprises one or more of the functions of one or more embodiments of the present invention. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It should be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

The present invention may be a specifically configured computing system, configured with hardware and/or software that is itself specifically configured to implement the particular mechanisms and functionality described herein, a method implemented by the specifically configured computing system, and/or a computer program product comprising software logic that is loaded into a computing system to specifically configure the computing system to implement the mechanisms and functionality described herein. Whether recited as a system, method, of computer program product, it should be appreciated that the illustrative embodiments described herein are specifically directed to an improved computing tool and the methodology implemented by this improved computing tool. In particular, the improved computing tool of the illustrative embodiments specifically provides an automatic audio description (AAD) generator that operates to automatically generate audio descriptions for video content and locate the audio descriptions in association with the video content, so as to enable users that are unable to fully view the video content, such as in the case of blind and visually impaired (BVI) users, to be able to experience and have knowledge of the visual elements of the video content. The improved computing tool implements mechanism and functionality, such as the AAD generator, which cannot be practically performed by human beings either outside of, or with the assistance of, a technical environment, such as a mental process or the like. The improved computing tool provides a practical application of the methodology at least in that the improved computing tool is able to obtain video elements/features through image recognition and analysis computing tools and automatically generate audio descriptions for the video elements/features and fit the audio descriptions into available rendering windows in the video content data to minimize overlap of audio content and maximize understanding of users as to the visual elements/features in the video content. Moreover, the improved computing tool provides computer capabilities to tailor the automatic audio descriptions to user preferences and to structural limitations of the video content. In addition, in some illustrative embodiments, the improved computing tool provides mechanisms that can automatically control the playback of video content to adjust the playback in order to present rendering windows in which automatically generated audio descriptions may be presented.

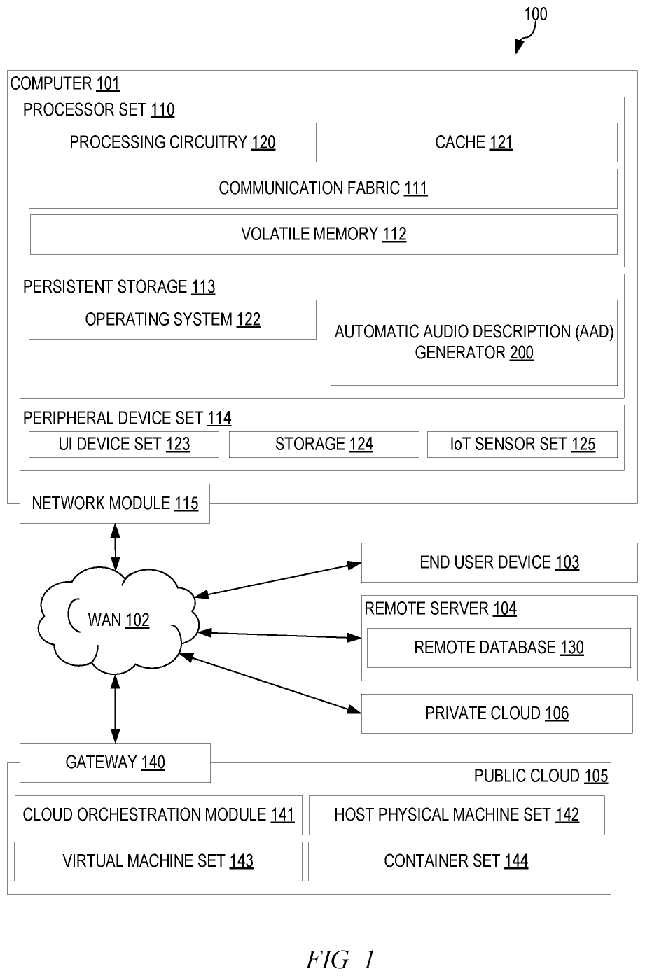

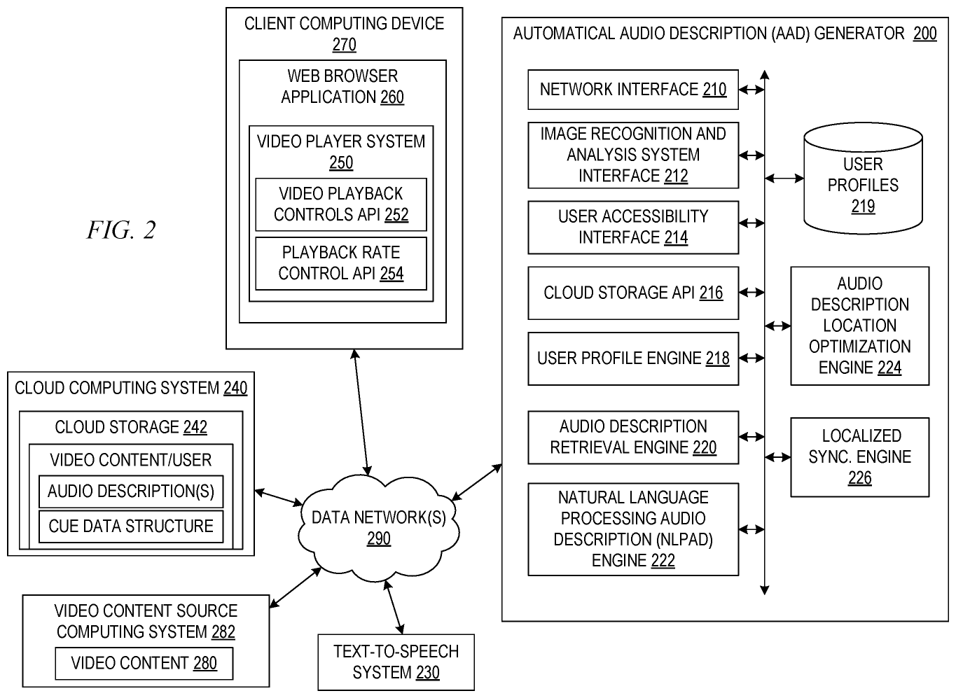

FIG. 1 is an example diagram of a distributed data processing system environment in which aspects of the illustrative embodiments may be implemented and at least some of the computer code involved in performing the inventive methods may be executed. That is, computing environment 100 contains an example of an environment for the execution of at least some of the computer code involved in performing the inventive methods, such as automatic audio description (AAD) generator 200, described in greater detail hereafter with regard to FIG. 2. In addition to AAD generator 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AAD generator 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in AAD generator 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in AAD generator 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As shown in FIG. 1, one or more of the computing devices, e.g., computer 101 or remote server 104, may be specifically configured to implement a AAD generator 200. The configuring of the computing device may comprise the providing of application specific hardware, firmware, or the like to facilitate the performance of the operations and generation of the outputs described herein with regard to the illustrative embodiments. The configuring of the computing device may also, or alternatively, comprise the providing of software applications stored in one or more storage devices and loaded into memory of a computing device, such as computing device 101 or remote server 104, for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of the illustrative embodiments and is not a general purpose computing device. Moreover, as described hereafter, the implementation of the mechanisms of the illustrative embodiments improves the functionality of the computing device and provides a useful and concrete result that facilitates automatic generation of audio descriptions for video content, especially for use by BVI users, so that users that are unable to fully experience visual elements of video content, whether because they are visually impaired or because of other factors, are presented with descriptions of these visual elements through automated audio descriptions to facilitated greater understanding of the video content.

FIG. 2 is an example block diagram illustrating the primary operational components of an automatic audio description (AAD) generator in accordance with one illustrative embodiment. The operational components shown in FIG. 2 may be implemented as dedicated computer hardware components, computer software executing on computer hardware which is then configured to perform the specific computer operations attributed to that component, or any combination of dedicated computer hardware and computer software configured computer hardware. It should be appreciated that these operational components perform the attributed operations automatically, without human intervention, even though inputs may be provided by human beings, e.g., requests to generate audio descriptions for a specified video content, and the resulting output may aid human beings, e.g., audio descriptions that are presented along with the specified video content and which are positioned relative to the video content being described such as to minimize overlap of audio and maximize understanding of visual elements of the video content. The invention is specifically directed to the automatically operating computer components directed to improving the way that audio descriptions for video content, especially for BVI users, is generated and associated with the video content, and providing a specific solution that implements logic to automatically generate these audio descriptions in accordance with user preferences and structural limitations of the video content, which cannot be practically performed by human beings as a mental process and is not directed to organizing any human activity.

As shown in FIG. 2, the automatic audio description (AAD) generator 200 includes a network interface 210, an image recognition and analysis system interface 212, a user accessibility interface 214, a cloud storage application programming interface (API) 216, a user profile engine 218, a user profile database 219, an audio description retrieval engine 220, an natural language processing audio description (NLPAD) engine 222, an audio description location optimization engine 224, and a localized synchronization engine 226. The AAD generator 200 operates in conjunction with an image recognition and analysis system 220, a text-to-speech system 230, a cloud computing system 240 providing cloud storage 242 services and infrastructure, and a video player system 250, such as may be provided via a web browser 260 or other content rendering application/hardware of a client computing device 270, for example. The AAD generator 200 may operate in conjunction with these other systems 220-270 via one or more data networks 290, for example. While these other systems 220-270 are shown as separate from the AAD generator 200 and separate from each other, it should be appreciated that in some illustrative embodiments, one or more of these separate systems 220-270 may be integrated with one another, e.g., the TTS system 230 may be integrated with the AAD generator 200, without departing from the spirit and scope of the present invention.

The AAD generator 200 operates with these other elements to retrieve and/or generator audio descriptions for a specified video content 280 for presentation to a user while playing the video content 280 via the video player system 250, where again the audio descriptions are audio speech that is descriptive of visual elements in the video content which may not otherwise be readily understood or made explicit in the original audio soundtrack of the video content, and thus, would not be available to blind or visually impaired persons or other users that are not accessing the visual aspects of the video content, e.g., users that are only listening to the audio soundtrack of the video content. The video content 280 may be streaming video content, such as from a video content source computing system 282 streamed to the client computing device 270 (as shown in the depicted example), or video content whose data is local to the client computing device 270. The operation of the AAD generator 200 may be invoked and performed prior to the playback of the video content 280 or dynamically while the video content 280 is being played for consumption by a user by the video player system 250. In the case of dynamic operation of the AAD generator 200 while the video content 280 is being played, the AAD generator 200 may operate in a lookahead mode of operation in which the AAD generator 200 performs its operations for portions of the video content 280 that are to be played by the video player system 250 at a future time point during the playback, while other portions of the video content 280 are currently being played by the video player system 250.

In accordance with one or more illustrative embodiments, a user of the web browser 260 on client computing system 270 may wish to access video content 280 for playback by a video player system 250 associated with the web browser 260. The video player system 250 may include video playback controls API 252 and a playback rate control API 254. The video playback controls API 252 may include user specified configuration information that may include accessibility options for specifying accessibility settings that the user wishes to implement when playing back video content, such as video content 280. These accessibility options may include invoking the improved computing tool operations/functionality of the illustrative embodiments for providing automatically generated (or retrieved) audio descriptions for the video content being played. The playback rate control API 254 may comprise controls for dynamically modifying the playback rate or speed of the video content, where this API 254 may be called by the AAD generator 200 to modify the playback rate when needed to provide rendering windows for inclusion of automatically generated audio descriptions.

In response to accessibility options being enabled via the video playback controls API 252 of the video player system 250, in response to the user selecting a video content 280 to play via the video player system 250, the video player system 250 may send a request to the AAD generator 200 to provide automatically generated audio descriptions for the video content 280. This request may specify the user requesting playback of the video content 280, the video content 280 for which playback is requested, and may, in some cases, provide the metadata 282 associated with the video content 280 for use in generating the audio descriptions. This metadata 282 may specify one or more types of video content, e.g., for the entire video content 280 and/or for individual scenes or segments of the video content 280, scene boundary points/markers within the video content 280, identifiers of video elements/features that have been previously identified via image recognition and analysis system 220 for a previous playback of the video content 280 if any, or the like. Each of these metadata may be associated with individual scenes or segments within the video content 280 such that correlations between the metadata and scenes/segments of the video content, such as by timestamp or the like, may be made.

The AAD generator 200 receives the request via the network interface 210 and passes the request to the user profile engine 218. The user profile engine 218 retrieves a user profile corresponding to the user specified in the request, from a user profile database 219. The user profile may be created and stored for the specified user at an earlier time, such as via the user registering with the AAD generator 200 via the user accessibility interface 214, for example. That is, the user may interface with logic of the user profile engine 218 to establish a user profile by inputting user characteristics and preferences including the desired level(s) of audio description for one or more types of video content, as well as enabling options for richness fallback, video element filters, lookback time filters, and the like. The user profile may be associated with a user identifier that may then be used with requests from the video player system 250 to specify the user and retrieve the corresponding user profile.

The identification of the video content 280 in the request may be provided to the audio description retrieval engine 220 along with user characteristics and preferences information from the retrieved user profile to determine whether a previously generated audio description, or set of audio descriptions, for the specified video content 280 and for users having similar characteristics and preferences to those specified in the user profile, exists in a cloud storage 242 of the cloud computing system 240. The audio description retrieval engine 220 may call the cloud storage API 216 to perform a search of the cloud storage 242 in the cloud computing system 240 for an existing audio description or set of audio descriptions, with the cloud storage API 216 or the audio description retrieval engine 220 comprising logic for evaluating similarities between users. That is, the cloud storage API 216 may identify or retrieve all previously generated audio descriptions for the specified video content 280 and then the audio description retrieval engine 220 (or API 216 in some cases) may execute logic on the user characteristics/preferences associated with the various previously generated audio descriptions, to determine which previously generated audio description(s) are associated with a most similar user to the user currently requesting playback of the video content 280 with audio descriptions, i.e., identified in the received request.

This evaluation of similarity may be based on a vectorization of the characteristics/preferences for both the requesting user and the user characteristics/preferences associated with the previously generated audio description(s), and performing a vector similarity analysis, for example, to determine how similar/dissimilar the vectors are. Of course, other mechanisms for evaluating similarity, such as weighted functions or the like, may be used to perform this evaluation as well, depending on the desired implementation. The result is a similarity measure or metric for each pairing of the characteristics/preferences of the requesting user with characteristics/preferences associated with previously generated audio descriptions, such that a pairing having a highest similarity measure may be selected, if any. This selected pairing may then have the similarity measure compared to a predetermined threshold similarity measure to determine if the similarity measure is sufficiently high that the corresponding audio descriptions may be used with the requesting user. If the similarity measure is not equal to or higher than the predetermined threshold, then no existing audio descriptions are determined to be appropriate for presentation to the requesting user and automatic audio description generation by the AAD generator 200 may then be invoked.

If the similarly measure is equal to or higher than the predetermined threshold, then the previously generated (and stored) audio description(s) for the video content 280 may be retrieved and provided to the video player system 250 at the client computing device 270 for use in playing the video content 280 for consumption by the user. The previously generated audio descriptions comprise the location, in terms of relative position to scene boundary points/markers and timestamps, where the audio descriptions are to be played as part of the audio soundtrack for the video content 280. Thus, the video player system 250 plays the video content 280 and the audio descriptions for the user, who may be a blind or visually impaired (BVI) user or user that is not able to view the visual elements of the video content 280 but is informed of the visual elements of importance and interest via the audio descriptions.

Assuming that no suitable existing audio descriptions are already stored in the cloud storage 242 for the specified video content 280 and users having sufficiently similar characteristics/preferences as the requesting user, the AAD generator 200 initiates operations to automatically generate audio descriptions for the video content 280. The AAD generator 200 invokes the NLPAD engine 222 and audio description location optimization engine 224 to automatically generate audio descriptions and locate them relative to the video content 280 in accordance with the user preferences from the user profile and in accordance with the video content 280 type, individual scene/segment types, and any other structural limitations from the boundary points/markers of scenes/segments in the video content 280, as specified by the metadata 282. The NLPAD engine 22 provides logic to perform operations to generate textual descriptions of the video elements/features extracted from the video content 280 by the image recognition and analysis system 220, in accordance with the user preferences. These textual descriptions are converted to audio data by a text-to-speech system 230. The audio description location optimization engine 224 comprises logic that then places the audio data in relation to the video content, e.g., temporally locating the audio data in relation to the temporal location of the video content, so as to optimize the placement with regard to overlap and structural limitations of the video content. The audio description location optimization engine 224 may further perform operations to automatically modify the level of detail or verbosity of the audio data in order to optimize the placement of the audio data.

That is, the AAD generator 200 when initiating operations to automatically generate audio descriptions for the video content 280, communicates with the image recognition and analysis system 220 via the interface 212 to request video elements/features for the video content 280. This may be for the entire video content 280, an upcoming portion of the video content 280 during dynamic runtime playback of the video content 280 by the video player system 250, or the like. The image recognition and analysis system 220 applies known or later developed image recognition and analysis logic to identify actions, objects, persons, and other video elements/features present in a portion of video content 280 and then classify and label these identified video elements/features in accordance with a known set of such actions, objects, persons, or the like, such as may be specified in one or more ontology data structures. The characteristics of the identified video elements/features may also be stored in association with the identified, classified, and labeled video elements/features, such as a timestamp of occurrence of the identified video element/feature, and the like.

The identified video elements/features may then be provided to the AAD generator 200 via the image recognition and analysis system interface 212. These video elements/features may then be filtered by filtering logic of the interface 212 in accordance with filtering criteria specified in the retrieved user profile. That is, as noted above, the user profile for the user may specify video element filters that indicate which video elements/features to use for audio description generation and/or which video elements/features to filter out from use for audio description generation. For example, features of a certain type, such as a background feature type, which holds features that describe the sky, the ground, large fields, a forest, etc. may be a feature type that is filtered out with regard to automatic generation of audio descriptions. In other cases, the user may not wish to hear audio descriptions of objects that are considered less significant in the scene or segment of video, with significance being measured by a percentage of displayed screen space that the object occupies.

In some illustrative embodiments, the video element filters may comprise a lookback time filter and the logic may maintain a historical data structure of video elements/features that have already been used to generate audio descriptions within a given time window of the video content 280 playback. The lookback time filter specifies a time period of an elapsed time of the video content playback in which the audio description of a video element or features is not to be repeated. That is, video elements or features can be filtered out based on when they last occurred in time relative to the current timepoint of the same video elements/features for which audio descriptions are being generated. For example, a value of 20 with regard to a lookback time filter associated with a particular video element/feature type indicates that the video element/feature of that specific type must have occurred longer than 20 seconds ago to be described again in an audio description. This helps to avoid frequent and repeated audio descriptions of the same video element/feature. Overriding criteria may also be specified which overrides this lookback time filter, such as a scene change, as indicated by traversal during playback of a scene boundary point/marker or other specification of a boundary of a scene or portion of the video content, e.g., if a video element/feature occurs in multiple sequential scenes, the scene change may permit inclusion of the audio description of that video element/feature again since the scene has changed, even if the occurrence of that video element/feature is within the lookback time filter time period.

The video element filters are applied to the identified video element/features provided by the image recognition and analysis system 220 to generate a filtered set of video elements/features. The filtered set of video elements/features are input to the NLPAD engine 222 which uses the classification/labels of the video elements/features to compose a textual description of the video elements/features in the portion of video content 280. The NLPAD engine 222 may utilize natural language processing logic and resources, e.g., dictionary data structures, thesaurus data structures, synonyms, antonyms, descriptor language terms/phrases, various ontologies of concepts, and the like, to compose a sentence or paragraph description from the combination of video elements/features provided in the filtered set of video elements/features.

The amount of detail and description present in the composed sentence or paragraph may be dependent upon the user preferences as noted previously. That is, as noted above, there may be predetermined levels of audio description established for providing more or less verbosity and detail in the audio description. The user may specify user preferences as to these levels with regard to different types of video content. Thus, the NLPAD engine 222 may use the user preferences specified in the user profile with regard to these levels of detail and apply the appropriate one(s) to the video elements/features of the particular portion of video content 280 based on the type of the portion of video content 280, where the type specifies at least one characteristic of the portion of video content 280, such as genre of video content, e.g., action, drama, comedy, news, sci-fi, adventure, fantasy, historical, etc., that can be used as an indicator of sizes of rendering windows that may be available in the video content. For example, a user may specify that they wish to have a minimum level of audio description for action videos, but a maximum level of audio description for drama videos. This may be done with regard to the video content 280 as a whole, or for individual scenes, segments, or portions of video content. The metadata 282 of the video content 280 comprises labels specifying types of the video content 280

As noted above, in some illustrative embodiments, three levels of audio description may be predefined, e.g., minimum, moderate, and maximum. For a minimum level of audio description, for example, the minimum audio description may include only an audio description of the video content elements shown on the screen. For a moderate level audio description, the moderate description may describe the elements with a more thorough description providing modifiers to the nouns/verbs but no positional information. For a maximum level audio description, the maximal video description provides a rich description of what is occurring in the video scene or segment including modifiers to the nouns/verbs and positional information. Depending on the particular level associated with the type of the video content 280 or portion of the video content from which the filtered video elements/features were extracted, a corresponding natural language textual description is generated having the corresponding level of detail.

The textual description generated by the NLPAD engine 222 may be provided to a text-to-speech system 230 for conversion to speech or audio data, e.g., audio data representing a person speaking the sentence or paragraph automatically generated by the NLPAD engine 222. The text-to-speech conversion performed may include translation to other languages, such as a language spoken by the user requesting the audio descriptions as specified in the user's profile, or the like. The audio data generated as a result will have a time span or temporal length denoted by a start and end time from which an elapsed time for the audio data may be determined. The audio data is returned by the text-to-speech system 230 to the AAD generator 200 which may then provide that audio data to the audio description location optimization engine 224 which performs operations to locate the audio description within a time window of the portion of video content 280 corresponding to the filtered video elements/features for which the textual description and corresponding audio data was generated.

The audio description location optimization engine 224 analyzes the existing audio soundtrack of the portion of video content 280 associated with the filtered video elements/features to identify one or more rendering windows within the audio soundtrack having a timespan equal to or greater than the length of the audio description. The rendering windows may comprise audio in the audio soundtrack that does not include dialog or other significant audio, e.g., sound amplitude or level higher than a predetermined threshold, for the portion of video content 280. Any suitable existing or later developed audio analysis may be used to identify windows of time within the portion of video content 280 where audio levels are low enough that the presence of automatically generated audio descriptions will not overlap or otherwise obfuscate significant audio content of the existing audio soundtrack of the portion of video content 280. If a rendering window having a timespan long enough to encompass the automatically generated audio description is found, then the audio description location optimization engine 224 may locate the audio description in the rendering window. In addition, the audio description location optimization engine 224 may further evaluate such rendering windows with regard to overlap with other automatically generated audio descriptions in proximity to the rendering window to ensure that there are no overlaps of audio descriptions. It should be appreciated that such rendering windows may include background audio that is in fact overlapped by the audio descriptions, but this audio is considered not significant to an understanding of the video elements/features of the video content, e.g., background nature sounds or the like may be present but overlapped by the audio description. Thus, audio descriptions are located at start and end timepoints in correlation with the timestamps of the portion of video content 280.

In locating the audio descriptions in rendering windows of the portion of video content 280, it is possible that a rendering window cannot be found that avoids overlap with significant existing audio content in the existing audio soundtrack or overlap with other audio descriptions. In such a case, if a richness fallback functionality is enabled, such as by setting an option for richness fallback feature enablement in the user profile, then the audio description location optimization engine 224 may iteratively try fallback levels of detail for generation of audio descriptions. With this richness fallback functionality, the mechanisms of the illustrative embodiments may automatically and dynamically fall back to lower levels of detail/verbosity, such as from a maximum level to the moderate, and then minimum options to check if they fit into the rendering window before the next boundary point/marker is processed without overlap with other significant audio content or other audio descriptions. This may be done iteratively going from a higher level of verbosity or detail to a lower level until a level of audio description is found that permits the audio description to be fit into the rendering window without overlap.

In some cases, even with the richness fallback functionality enabled, there may be situations in which even the lowest level of audio description may not be able to fit within a rendering window of the portion of video content 280. In such cases, if the lowest level of audio description is not enough to keep the pace with the video, the playback speed or rate of the portion of video content 280 may be adjusted to increase the length of a rendering window to permit inclusion of the audio description. That is, appropriate data may be associated with the audio description content to invoke controls of the video player system 250 to modify the video playback speed/rate when playing back the portion of video content 280. Such controls may be invoked by the localized synchronization engine 226 while the video content 280 is being played back by the video player 250, such as in a data streaming embodiment. That is, as the audio descriptions are provided to the video player system 250 for playing along with the video content 280 and existing audio soundtrack, the data specifying modifications to video playback speed/rate may be transmitted to the video player system 250 to cause the video playback rate control API 254 to modify the video playback speed/rate accordingly, to maintain synchronization between the video content and the audio content comprising the audio soundtrack and the automatically generated audio descriptions. Thus, in some illustrative embodiments, the video playback may be automatically adjusted to allow for the inclusion of an automatically generated audio description of a given scene of the video content. The speed of the video playback may be likewise adjusted back to its original speed once it is determined that the video playback at its original speed will allow for rendering windows using at least the minimum level of audio description.

The result of the AAD generator 200 operations is a correlation of the original existing video content 280 and its audio soundtrack, with automatically generated audio descriptions and scene boundary points/markers in the video content 280 such that automatically generated audio descriptions for the visual aspects of the portions of video content 280 may be output to users along with the video content 280 and its audio soundtrack. The AAD generator 200 thereby provides automated computing tools for generating audio descriptions for video elements of video content 280 for output when playing the video content 280 such that blind and visually impaired persons, or other persons that are not able to perceive the visual elements during the playback, may make use of the audio descriptions to gain a greater understanding of what is being visually represented in the video content 280. The AAD generator 200 is able to optimize the location of these automatically generated audio descriptions so as to minimize overlap with other audio content and other audio descriptions. This optimization may include modifying levels of detail or verbosity of the audio descriptions so as to fit the audio descriptions into available rendering windows, and in some cases modifying the playback speed/rate of the playing of the video content 280 to allow for inclusion of the automatically generated audio descriptions.

The data structures, comprising the audio descriptions, video content 280, existing audio soundtrack, scene boundary points/markers metadata, playback speed control data, and the like, may be stored in a cloud storage 242 of the cloud computing system 240 for later retrieval and use with subsequent requests for automatically generated audio descriptions. These data structures may be correlated with an identifier of the user and the user's characteristics for use in identifying similar users during subsequent request processing. Thus, during processing of subsequent requests for automatically generated audio descriptions, a search may be made of the cloud storage 242 for audio descriptions that have been previously generated for the video content 280, and for the same user as indicated by the user identifier. If such audio descriptions cannot be found, then a search for similar users may be made based on the characteristics of the users as discussed previously. If such a similar user is not found, then the automatic generation of the audio descriptions may be initiated as discussed above. If previously generated audio descriptions for the same user or for a similar user are found, then those may be retrieved and sent as the audio descriptions to be presented to the user when playing back the video content 280 via the video player system 250, thereby avoiding having to re-generate the audio descriptions.

Thus, in summary and as an overview, in accordance with one or more illustrative embodiments, the AAD generator 200 in conjunction with the image recognition and analysis system 220, text-to-speech system 230, cloud computing system 240, and video player system 250 at the client computing device 270, reads the video content 280, extracts video elements/features from the video and classifies them (e.g. red car, brown cat, . . . ), reads the user's preferences from a user profile, and generates an audio file based on which features were located in the scene(s) either prior to or during playing of the video content 280 via the video player system 250. The audio file can be used by the video player system 250 which adds the audio descriptions of the audio file as an additional audio layer to the video content 280 and replays the video content 280 according to the boundary points/markers and any cue points/markers that may have been generated to adjust speed/rate of playback. That is, cue points/makers may be inserted into scenes and may include speed information for specifying instructions for when and how the video content 280 should be slowed down, if needed, to allow for the presentation of the audio descriptions in the audio file. In some illustrative embodiments, the user can enable a richness fallback function if the user wants to reduce the description in addition to, or instead of, slowing down the video content 280 playback in order to permit insertion of audio descriptions.

Thus, the audio descriptions may be generated by first extracting, from the video content 280, the video elements/features using image recognition and analysis logic, with timestamps and classifications, etc. The extracted video elements/features are filtered according to the user's accessibility settings/preferences. The filtered video elements/features are converted to a textual descriptions, e.g., one or more sentences, paragraphs, or the like, based on the user's settings with regard to a level of audio description (e.g., minimum, moderate, maximum, etc.) and the resulting textual description may be possibly translated to another language, such as a language spoken by the user. The textual description is then converted to speech in the form of audio data. The speech is mixed into a final audio file at the point in time where the extracted video elements/features occur.

The length, in terms of time, of the spoken sentences/paragraphs is determined. The start of the next set of sentences/paragraphs of speech for a next automatically generated audio description or dialog in the existing audio soundtrack of the video content 280 is obtained from the boundary points/markers representing the boundaries of a rendering window or the boundaries of the scene or segment of video content 280. If there is an overlap between the end of the audio description's sentences/paragraphs and the start of the next set of sentences/paragraphs, the illustrative embodiments check whether the user has chosen the richness fallback option. If so, a lower level of audio description detail and verbosity may be selected, e.g., the minimum or moderate option, to use for generation of an audio description and then perform similar operations as noted above in order to check if there is an overlap. If there is no overlap, or if the richness fallback option has not been chosen, the time of the overlap is added to a cue sheet data structure (which stores the cue points/markers for the video content 280) as a delay of a certain type (an “op”, see code example below) and an instruction that resumes to normal replay, as “SPEED 1.0”.

The process is repeated through the entire video content 280, appending operations to the cue sheet data structure, and mixing sentences/paragraphs of spoken speech into the final audio file. The cue sheet data structure and the audio file, having the audio descriptions and their temporal locations, are saved in a non-volatile memory, e.g., written to disk or saved in the cloud storage 242 of the cloud computing system 240. The cloud storage API 216 can return the cue points/markers of the cue sheet data structure in any format, e.g., JSON, which can be used with the audio file to synchronize playback of the video content 280 with the audio file in accordance with the specified cue points/markers.

To further explain one illustrative embodiment of the present invention, the following description provides example algorithms that may be implemented by the various components shown in FIG. 2 to perform their operations with regard to the automatic generation of audio descriptions for supplementing the video content and to give blind and visually impaired persons, or other individuals that are not able to view the visual features of the video content, an audible representation of the visual features. As a first example algorithm, as noted above, the video elements/features identified by an image recognition and analysis system operating on video content may be filtered in accordance with user specified video element filters, such as may be specified in a user profile or the like. The following is an example of pseudocode for specifying such video element filters and for obtaining video elements (referred to in the pseudocode as “entities”) and filtering them in accordance with the video element filters, where this pseudocode assumes that video element/feature types have been previously defined. For purposes of this example, it is assumed that the user has, via a user interface, previously defined a user profile having the following example settings/preference

Cue point rate=X (e.g., evenly distributed from start)
Speech voice = male 1 (e.g., male1, ..., female1, ...)
Speech speed = normal
discarded_feature_types = [“background”, “furniture”, “sky”, “ground”, “building”,
“plant”...]
discarded_feature_time_type = 0 # (always or overridden time limit e.g., 60 sec)
entity_time_limit = 20 # (e.g., 20 sec)
entity_area_limit = 0.1 # (e.g. ,0.1%, or the value 0 will never skip on size)
entity_type_sorted = [“human”, “animal”, “vehicle”, “furniture”](on priority)
max_entities = 5 (to describe) # For example if <5> and there are 10, then only 5
topmost are described
included modifiers (e.g., adjectives and/or prepositions): # e.g. a young man to the
left of a blue car
sentence_length (e.g., minimum, moderate, maximum)
fallback (true or false) # Sets the sentence length temporary to a smaller level.

With this user profile as an example, the pseudocode for filtering the video elements/features (or entities) may be as follows:

```
Get settings using the Cloud API
Extract entities and entity types at a certain rate
For each extraction:
  remaining_entities = [ ]
  For each entity:
    If entity type in discarded_feature_types:
      if discarded_feature_time_type == 0: # (always)
        continue
      if time since latest occurence <
      discarded_feature_time_type: # (time limited)
        continue
    ElseIf time since latest occurence < entity_time_limit:
      continue
    Get the enclosing box (EB) of feature on image
    Get area of EB related to image size
    If area < entity_area_limit:
      continue
    Map the location of EB on the image onto a grid layout (e.g., 16x9)
    Append entity to remaining_entities
  # Prioritize remaining entities according to entity_type_sorted
  Sort remaining_entities on entity_type_sorted
  # Keep the ones in the top (max_entities)
  remaining_entities = remaining_entities[:max_entities]
```

As noted above, the filtered set of video elements/features, e.g., the “remaining_entities” in the above pseudocode, may be used as the basis for generating a natural language processing based set of one or more sentences for generation of the audio description. The following is an example of pseudocode for generating a natural language processing sentence based on the filtered set of video elements/features and user settings/preferences.

Obtain user settings, by invoking a function on the Cloud API Settings:

```
  included_modifiers (adjectives and/or prepositions): #
  e.g. a young man to
the left of a blue car
  sentence_length (minimum, moderate, maximum)
```

Receive a set of entities from the customized feature filter:

```
  “““For example:
  entities = [{“type”: “vehicle”, “entity”: “car”, “modifiers”:
  “red”, “size”: “3”,
“box”; [7, 8, 8, 8]},
  {“type”: “background”, “entity”: “sky”, “modifier”: “blue”,
  “size”: “25”,
“box”: [0, 0, 8, 2]},
  {“type”: “furniture”, “entity”: “chair”, “modifier”: “”,
  “size”: “7”, “box”: [4, 4,
4, 5]}]
  ”””
```

For each entity:

```
  If sentence_length == “maximum”:
    If “prepositions” in included_modifiers:
      Find the entity “closest_entity” in the list of entities which is closest in the grid
layout on the screen
      Get its preposition as “pre” = “above”, “below”, “to the left” or “to the right”.
      If “adjectives” in included_modifiers:
        Get the indefinite_article (closest_indef) for the modifier for closest_entity or a
default value if not available
        Get the indefinite_article entity_indef for the modifier for entity or a default
value available if not available
        sentence = entity_indef + entity_modifier + entity + pre + closest_indef +
closest_entity_modifier + closest_entity
      Else:
        Get the indefinite_article (closest_indef) for closest_entity or a default value if
not available
        Get the indefinite_article entity_indef for entity or a default value available if not
available
        sentence = entity_indef + entity + pre + closest_indef + closest_entity
  If sentence_length == “moderate”:
      If “adjectives” in included modifiers:
        Get the indefinite_article entity_indef for the modifier for entity or a default
value available if not available
        sentence = entity_indef + entity_modifier + entity
      Else:
        Get the indefinite_article entity_indef for entity or a default value available if not
available
        sentence = entity_indef + entity
  If sentence_length == “minimum”:
      Get the indefinite_article entity_indef for the entity or a default value available if
not available
      sentence = entity_indef + entity
```

The natural language processing generated set of one or more sentences for inclusion in the audio description may be converted to a speech or audio data that represents the text as audible content, e.g., spoken sentences, for the audio description. The audible content has a corresponding time length or size which may be used by the optimization mechanisms of the illustrative embodiments to locate the audio description relative to time points of the video content. In some illustrative embodiments, this optimization of the location of the audio descriptions is in relation to boundary points/markers associated with the video content, where these boundary points/markers may designate boundaries of portions of the video content. The boundaries may be associated with the beginning and ending of scenes or segments of the video content or may be within scenes or segments of the video content, such as in the case of rendering windows or the like.

As noted previously, in some cases, the audio description cannot fit within the given rendering window due to the size of the audio data in terms of temporal length, e.g., there may be a relatively large number of video features identified for a portion of the video content. In such cases, cue points may be inserted to adjust the speed or rate of the playback of the video content and thereby extend the rendering window. The following pseudocode is an example of code for attempting to locate an audio description relative to the video content and insertion of cue points/markers.

Get the cue point (CP1) and the next cue point (CP2) from the cloud storage by invoking a REST call over the cloud storage API
Calculate the time difference T_delta between CP2 and CP1
Render the paragraph of sentences as audio data, i.e., an audio paragraph sample
Get the length (L) in seconds of the audio paragraph sample

### If L>T_delta:

Check if the user has enabled richness fallback, then repeat rendering with reduced richness until it fits

If it still does not fit, then:
Calculate how much the video must be slowed down to catch up with the audio
Add data to the cue points as a slow down and back to normal speed again, together with timestamps.

The illustrative embodiments provide an improved computing tool and improved computing tool operations/functionality to automatically generate audio descriptions for image content. The illustrative embodiments utilize artificial intelligence (AI) based image analysis on image content, hereafter assumed to be digital videos (but also applicable to still image content as well), to identify elements of the video and extract them as video features, e.g., characters, objects, actions being performed, scene changes, on-screen text, and other visual elements of the video. A user customized filter may then be applied to these video features to identify video features of interest and to identify a desired level of audio description for the particular video content, or portion of video content, e.g., particular scenes or types of scenes present in the video. A natural language processing (NLP) engine operates on the filtered video features to construct a textual description of the filtered video features in accordance with the user's desired level of audio description and structural elements of the video content. The textual description may then be converted to an audio description by text-to-speech (TTS) logic, such as IBM Watson TTS™, available from International Business Machines (IBM) Corporation of Armonk, New York, or the like. The audio descriptions generated in this way may then be located with respect to the video content in accordance with the rendering windows available in the audio soundtrack of the video content so as to minimize overlap with significant audio content of the original audio soundtrack and overlap with other audio descriptions. This may include using richness fallback options and/or adjusting the speed of playback of the video content to allow for greater time and/or longer length rendering windows for insertion of the audio descriptions.

These features of the illustrative embodiments operate to provide improved computing tools and improved computing tool operations/functionality to enhance replay of videos or presentation of image content, such that blind and visually impaired (BVI) persons are informed of visual features of the video content that are not otherwise able to be discerned by them from the associated audio content, e.g., the soundtrack. The mechanisms of the illustrative embodiments leverage artificial intelligence (AI) based image recognition, analysis, and classification computing tools to identify video elements/features, classify them, and label them. The mechanisms of the illustrative embodiments augment these AI mechanisms by providing additional specific computing mechanisms that operate to automatically generate audio descriptions in accordance with the structural limitations of the video content and corresponding audio soundtracks, the preferences of users, and various filters and optimizations to minimize audio overlap of audio descriptions. The resulting improved computing tool and improved computing tool operations/functionality serve to automatically and dynamically enhance the experience of BVI users when consuming video content and avoid the significant and impractical manual effort and expense that might otherwise be required especially when one considers the speed and volume of video content being generated and disseminated via data networks, such as the Internet, on a daily basis.

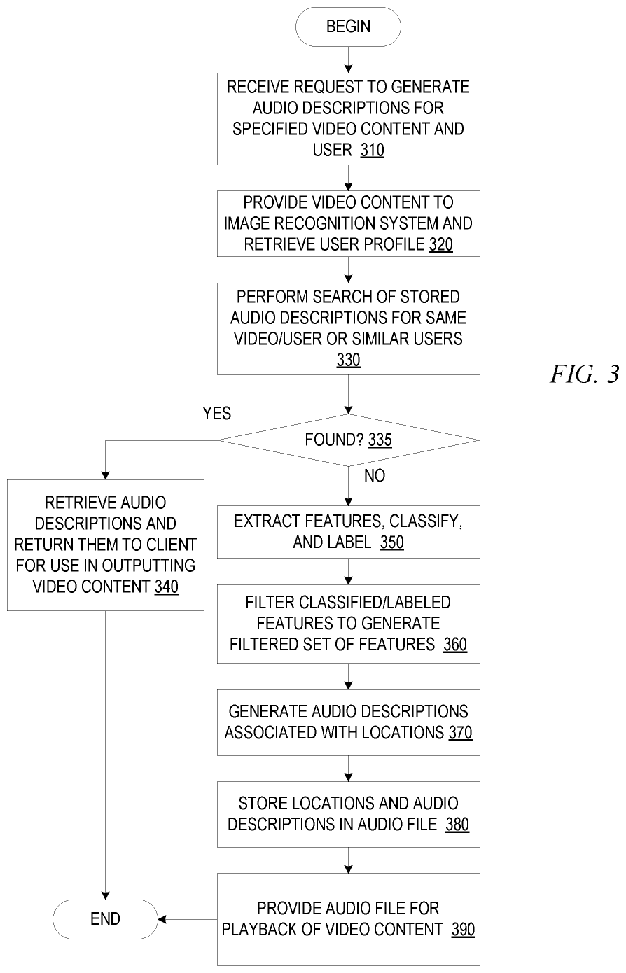

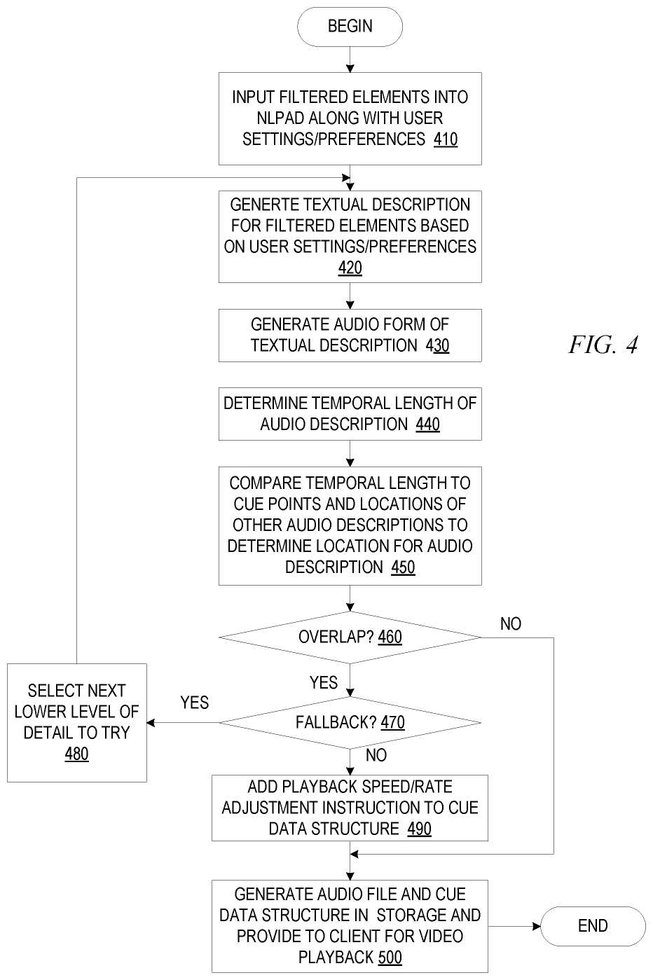

FIGS. 3-4 present flowcharts outlining example operations of elements of the present invention with regard to one or more illustrative embodiments. It should be appreciated that the operations outlined in FIGS. 3-4 are specifically performed automatically by an improved computer tool of the illustrative embodiments and are not intended to be, and cannot practically be, performed by human beings either as mental processes or by organizing human activity. To the contrary, while human beings may, in some cases, initiate the performance of the operations set forth in FIGS. 3-4, and may, in some cases, make use of the results generated as a consequence of the operations set forth in FIGS. 3-4, the operations in FIGS. 3-4 themselves are specifically performed by the improved computing tool in an automated manner.

FIG. 3 is a flowchart outlining an example overall operation for automatically generating audio descriptions for video content in accordance with one illustrative embodiment. As shown in FIG. 3, the operation starts by receiving a request to generate audio descriptions for a specified video content for a specified user (step 310). The video content is provided to an image recognition and analysis system for processing and the corresponding user profile for the user specified in the request is retrieved (step 320). A search of stored sets of audio descriptions for the same video content and the same user or similar users may be performed (step 330) and if a set of audio descriptions for the same video content and same user or sufficiently similar user is found (step 335), the operation may retrieve those audio descriptions and present them for use in performing playback of the video content (step 340).

Assuming no previously generated audio descriptions are available for the video content and the same user or similar user (step 335), the image recognition and analysis system extracts video elements/features of the video content, and then classifies and labels these video elements/features (step 350). The classified/labeled video elements/features are associated with timestamps within the video content. These video elements/features are filtered in accordance with user settings/preferences as set forth in the retrieved user profile and the classifications/labels associated with the video elements/features (step 360). This results in a filtered set of video elements/features.

The filtered set of video elements/features are then utilized to generate audio descriptions in association with boundary points/markers in the video content. (step 370). The boundary points/markers may be previously defined, such as in the case of scene boundaries, or may be defined in accordance with user settings/preferences, e.g., a uniform spacing along the video content or the like. The audio description generation may be performed, for example, in accordance with the operations outlined in FIG. 4, as described hereafter, and in accordance with one or more of the illustrative embodiments discussed previously. The boundary points/markers and the audio descriptions may be stored in a data structures in a non-volatile storage, such as a non-volatile memory of a computing device, cloud storage system, or the like, for later use in playing the video content and/or retrieval for the same or similar users (step 380). The data structures are provided to the client computing device from which the request was received such that the video content is then played via a video player system at a client computing device in accordance with any inserted cue points/markers and corresponding audio descriptions and their temporal locations such that the playback of the video content includes the video data, the original audio soundtrack of the video data, and the audio descriptions that were automatically generated/retrieved and located relative to the video data in accordance with the cue points/markers (step 390). The operation then terminates.

FIG. 4 is a flowchart outlining an example operation for automatically generating cue points/markers and locating audio descriptions relative to the cue points/markers in accordance with one illustrative embodiment. The operation outlined in FIG. 4 may be implemented, for example, as part of step 370 in FIG. 3 with regard to the generation of audio descriptions. The operation outlined in FIG. 4 assumes that time stamped video elements/features have already been obtained and filtered via the mechanisms discussed above. The video elements/features that remain after such filtering are then used by the operation of FIG. 4 as a basis for generating an audio description of those remaining video elements/features.

As shown in FIG. 4, the operation starts by inputting the filtered video elements/features into a natural language processing audio description (NLPAD) engine along with user settings/preferences for the user, e.g., level of detail, settings of specific types of content to include in textual descriptions, and the like (step 410). The NLPAD engine generates a textual description for the filtered video elements/features (step 420). An audio representation of the textual description is automatically generated, such as by using a text-to-speech system or the like, to thereby generate audio data for the audio description (step 430). The temporal length of the audio data is determined (step 440) and compared to the boundary points/markers and locations of other audio descriptions relative to the video content to determine a location of the audio data (step 450). A determination is made as to whether an overlap of the audio data with other audio descriptions or audio soundtrack features of the original audio soundtrack results (step 460). If so, a determination is made as to whether the user has enabled richness fallback functionality in the user profile settings/preferences (step 470). If so, then a next lower level of detail may be selected (step 480) and the operation returns to step 420.

If the richness fallback functionality has not been enabled by the user, then a playback speed/rate adjustment instruction is added by the insertion of a cue point into a cue data structure, so as to automatically adjust the playback speed/rate of the video content and increase the available rendering window for adding the audio description and avoid overlap (step 490). Thereafter, or if there is no overlap identified, then the audio descriptions are compiled into an audio file with timing, e.g., temporal location information, corresponding to the optimized locations of the audio descriptions, and the cue data structure specifying the cue points/markers, are stored in the cloud storage and output for use in playback of the video content (step 500). The operation then terminates.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system, for generating audio descriptions of visual elements of video content, the method comprising:
receiving a plurality of extracted video features for the video content from an image recognition and analysis computing system that performs image recognition operations to extract video features from the video content;
generating, based on the extracted video features, one or more audio descriptions that describe the extracted video features audibly;
determining at least one temporal location within the video content in which to place the one or more audio descriptions, wherein the at least one temporal location is determined based on a criterion to minimize overlap of the one or more audio descriptions with other audio features of the video content and other audio descriptions;
generating an audio description data structure based on the one or more audio descriptions and the at least one temporal location within the video content for the one or more audio descriptions; and
providing the audio description data structure to a client computing device for playback of the video content and output of the one or more audio descriptions during the playback of the video content in accordance with the audio description data structure.

2. The method of claim 1, wherein the one or more audio descriptions are audio descriptions comprising descriptive audio content for presentation to blind and visually impaired (BVI) persons to describe visual features of the video content that are not able to be perceived by the BVI persons.

3. The method of claim 1, wherein generating one or more audio descriptions comprises:
retrieving a user profile corresponding to a user requesting generating of the one or more audio descriptions for the video content, wherein the user profile specifies an audio description detail level setting specifying a level of detail to be included in the one or more audio descriptions; and
generating the one or more audio descriptions based on the audio description detail level setting.

4. The method of claim 3, wherein the audio description detail level setting is one of a plurality of predetermined audio description detail levels, and wherein each predetermined audio description detail level comprises a different amount of detail from other predetermined audio description detail levels with regard to descriptions of video features to be included in audio descriptions.

5. The method of claim 4, wherein the plurality of predetermined audio detail levels comprises:
a first predetermined audio description detail level comprises identifiers of the video features, but no location information specifying a relative location of the video features to one another, and no descriptor terms associated with the video features,
a second predetermined audio description detail level comprises the identifiers of the video features and descriptor terms associated with the video features, but no location information, and
a third predetermined audio description detail level comprises the identifiers of the video features, the location information, and descriptor terms associated with the video features.

6. The method of claim 4, wherein determining the at least one temporal location within the video content comprises iteratively generating audio descriptions at different predetermined audio description detail levels until an audio description having a temporal length that fits within a rendering window, with a predetermined level of acceptable overlap with other audio features and other audio descriptions, is generated.

7. The method of claim 1, further comprising:
performing a search of stored audio description data structures in a storage system based on an identification of the video content and at least one characteristic of a user requesting generation of the one or more audio descriptions, to identify a matching audio description data structure corresponding to the video content ant the at least one characteristic of the user; and
in response to finding the matching audio description data structure in the storage system, retrieving the matching audio description data structure and providing the matching audio description data structure to the client computing device as the audio description data structure.

8. The method of claim 7, wherein the at least one characteristic of the user comprises one or more of an identifier of a visual impairment of the user or a specified level of detail for inclusion in audio descriptions of video features.

9. The method of claim 7, wherein performing the search of the stored audio description data structures comprises generating a measure of similarity between characteristics of the user and characteristics of other users for which audio description data structures are stored, and retrieving an audio description data structure associated with a relatively highest similarity other user as the matching audio description data structure.

10. The method of claim 1, wherein the plurality of extracted video features is a filtered set of extracted video features having fewer extracted video features than an original set of extracted video features extracted from the video content by the image recognition and analysis system, and wherein the filtered set of extracted video features is generated by filtering the original set of extracted video features in accordance with one or more user specified filter criteria that specify types of extracted features for which audio descriptions are not to be generated.

11. A computer program product comprising a computer readable storage medium having a computer readable program stored therein, wherein the computer readable program, when executed on a data processing system, causes the data processing system to:
receive a plurality of extracted video features for the video content from an image recognition and analysis computing system that performs image recognition operations to extract video features from the video content;
generate, based on the extracted video features, one or more audio descriptions that describe the extracted video features audibly;
determine at least one temporal location within the video content in which to place the one or more audio descriptions, wherein the at least one temporal location is determined based on a criterion to minimize overlap of the one or more audio descriptions with other audio features of the video content and other audio descriptions;
generate an audio description data structure based on the one or more audio descriptions and the at least one temporal location within the video content for the one or more audio descriptions; and
provide the audio description data structure to a client computing device for playback of the video content and output of the one or more audio descriptions during the playback of the video content in accordance with the audio description data structure.

12. The computer program product of claim 11, wherein the one or more audio descriptions are audio descriptions comprising descriptive audio content for presentation to blind and visually impaired (BVI) persons to describe visual features of the video content that are not able to be perceived by the BVI persons.

13. The computer program product of claim 11, wherein generating one or more audio descriptions comprises:
retrieving a user profile corresponding to a user requesting generating of the one or more audio descriptions for the video content, wherein the user profile specifies an audio description detail level setting specifying a level of detail to be included in the one or more audio descriptions; and
generating the one or more audio descriptions based on the audio description detail level setting.

14. The computer program product of claim 13, wherein the audio description detail level setting is one of a plurality of predetermined audio description detail levels, and wherein each predetermined audio description detail level comprises a different amount of detail from other predetermined audio description detail levels with regard to descriptions of video features to be included in audio descriptions.

15. The computer program product of claim 14, wherein the plurality of predetermined audio detail levels comprises:
a first predetermined audio description detail level comprises identifiers of the video features, but no location information specifying a relative location of the video features to one another, and no descriptor terms associated with the video features,
a second predetermined audio description detail level comprises the identifiers of the video features and descriptor terms associated with the video features, but no location information, and
a third predetermined audio description detail level comprises the identifiers of the video features, the location information, and descriptor terms associated with the video features.

16. The computer program product of claim 14, wherein determining the at least one temporal location within the video content comprises iteratively generating audio descriptions at different predetermined audio description detail levels until an audio description having a temporal length that fits within a rendering window, with a predetermined level of acceptable overlap with other audio features and other audio descriptions, is generated.

17. The computer program product of claim 11, further comprising:
performing a search of stored audio description data structures in a storage system based on an identification of the video content and at least one characteristic of a user requesting generation of the one or more audio descriptions, to identify a matching audio description data structure corresponding to the video content ant the at least one characteristic of the user; and
in response to finding the matching audio description data structure in the storage system, retrieving the matching audio description data structure and providing the matching audio description data structure to the client computing device as the audio description data structure.

18. The computer program product of claim 17, wherein the at least one characteristic of the user comprises one or more of an identifier of a visual impairment of the user or a specified level of detail for inclusion in audio descriptions of video features.

19. The computer program product of claim 17, wherein performing the search of the stored audio description data structures comprises generating a measure of similarity between characteristics of the user and characteristics of other users for which audio description data structures are stored, and retrieving an audio description data structure associated with a relatively highest similarity other user as the matching audio description data structure.

20. An apparatus comprising:
at least one processor; and
at least one memory coupled to the at least one processor, wherein the at least one memory comprises instructions which, when executed by the at least one processor, cause the at least one processor to:
receive a plurality of extracted video features for the video content from an image recognition and analysis computing system that performs image recognition operations to extract video features from the video content;
generate, based on the extracted video features, one or more audio descriptions that describe the extracted video features audibly;
determine at least one temporal location within the video content in which to place the one or more audio descriptions, wherein the at least one temporal location is determined based on a criterion to minimize overlap of the one or more audio descriptions with other audio features of the video content and other audio descriptions;
generate an audio description data structure based on the one or more audio descriptions and the at least one temporal location within the video content for the one or more audio descriptions; and
provide the audio description data structure to a client computing device for playback of the video content and output of the one or more audio descriptions during the playback of the video content in accordance with the audio description data structure.
